(19) United States
(12) Patent Application Publication
(10) Pub. No.: US 2022/0041001 A1
(43) Pub. Date: Feb. 10, 2022

(54) A MACHINE FOR PROCESSING SHEETS FOR BINDING THE SHEETS TO FORM A BOOK AND A METHOD THEREOF

(71) Applicant: Nilesh Dhirajlal Parmar, Rajkot (IN)

(72) Inventors: Nilesh Dhirajlal PARMAR, Rajkot (IN); Pradeep KOSHTI, Indore, MP (IN)

(21) Appl. No.: 17/278,631

(22) PCT Filed: Sep. 22, 2019
(86) PCT No.: PCT/IB2019/058010

§ 371 Date: Mar. 22, 2021

(30) Foreign Application Priority Data
Sep. 23, 2018 (IN) 201821035765

(51) Int. Cl. B42C 19/02; B42C 5/00; B42C 9/00

(52) U.S. Cl. CPC B42C 19/02; B42C 9/0081; B42C 5/00

(57) ABSTRACT

A machine for processing sheets for binding the sheets to form a book and a method of manufacturing is provided. The machine includes, a first receiver and a second receiver to receive to receive a main sheet (101) and an auxiliary sheet (103) respectively. The machine further includes a disposer to dispose an adhesive strip (105) to couple the main sheet (101) and the auxiliary sheet (103) and to form a gutter (107) between the main sheet (101) and the auxiliary sheet (103). The distance (g1, g2) between the main sheet 101 and the auxiliary sheet (103) is a gutter-size (g1,g2). The machine further provides an adjuster to adjust relative position of the main sheet (101) and the auxiliary sheet (103) and any one or both of the gutter-size (g1,g2) and width (x1, x2) of the auxiliary sheet (103) based on the position of the main sheet (100) in the book. The first receiver and the second receiver positions the auxiliary sheet (103) adjacent to a first edge of the main sheet (101) and the first edge is proximal to a biding edge of the book.

### TECHNICAL FIELD

The present subject matter generally relates to a method of processing a sheet, and book thereof, and a machine and method of manufacturing the machine thereof.

### BACKGROUND

U.S. Pat. No. 9,440,479B2 of Cannon Inc. and Japanese Patent publication No. 09-123636 of Karuchi KK both discuss methods of making a photo album by binding printed sheets. However, both the documents have number of new problems.

FIG. 1a through FIG. 1c show schematic representation of figures of the above referred Japanese patent document. In this method a sheet 1 and sheet 2 are coupled using an adhesive sheet 3, such that a gap 8 is created between sheet 1 and sheet 2 to provide a raw sheet 10 with the gap 8 (See, FIG. 1a). The raw sheet 10 is laminated to provide a second raw sheet 20, the gap 8 also get covered by the lamination and generates a groove 8′ (See, FIG. 1b). The second raw sheet 20 is cut along the dotted lines 7, this gets read of the adhesive sheet 3 and also the size of the sheet 1 is reduced to what is shown in the FIG. 1c. A plurality of holes 9 are formed for sewing in the groove part 8′ this provides sheet 30 (See, FIG. 1c). The hashed area 13 is where the content of the page is printed. There are a number of limitations of this method. Some of the prominent limitation is the method has accuracy and finishing limitations and the method is waste, skill and time intensive method. Some limitations of the method have been discussed by the above US Patent document of Cannon Inc.

FIG. 2a through FIG. 2d are extracted from the figures of the above referred US Patent. In this solution, a sheet 50 is partly placed on a holding surface 33a and partly on the holding surface 40a. The holding surface 40a is adjusted by moving in the direction E and the sheet 50 is snug fit on to the holding surface 33a and 40a using suction. The sheet is cut by moving blades 42a and 42b. Once the sheet 50 is cut into portions 50a and 50b, the holding surfaces 33a and 40a is moved in the direction E and F respectively to form a large gap. The portions 50a and 50b are pasted using adhesive tapes 51a and 50b leaving a small gap between the portions 50a and 50b.

The US Patent document discusses the quality deviation or non-uniformity related limitations of the Japanese document. These limitations relating to quality deviation are shown in FIG. 16a through FIG. 16c of the US document. These same are being reproduced here as FIG. 3a through FIG. 3c. In that the non-uniformity in parallelism between the edges of the gaps introduced by the Japanese document due to use laminated groove 8′ (See, FIG. 1b) as hinge and due to the adhesive auxiliary sheet 3. Which results in wedge-shaped binding—a relatively poor quality finish—(See, FIG. 3a-FIG. 3c). While the US patent attempts to solve some of the limitations of the Japanese patent document, it creates new problems of its own. Further, the US patent also leaves some of the limitations of the Japanese patent document unaddressed.

### SUMMARY OF THE SUBJECT MATTER

According to one aspect, the present subject matter provides a machine for processing sheets for binding the sheets to form a book comprising: a first receiver to receive a main sheet (101); characterized in that a second receiver to receive an auxiliary sheet (103); a disposer to dispose an adhesive strip (105) to couple the main sheet (101) and the auxiliary sheet (103) and to form a gutter (107) between the main sheet (101) and the auxiliary sheet (103), wherein the distance (g1, g2) between the main sheet 101 and the auxiliary sheet (103) is a gutter-size (g1,g2); and an adjuster to adjust relative position of the main sheet (101) and the auxiliary sheet (103) and any one or both of the gutter-size (g1,g2) and width (x1, x2) of the auxiliary sheet (103) based on the position of the main sheet (100) in the book, and wherein the first receiver and the second receiver positions the auxiliary sheet (103) adjacent to a first edge of the main sheet (101); wherein the first edge is proximal to a biding edge of the book. In a first embodiment, the adjuster is configured to adjust any one or both of the gutter-size (g1,g2) and width (x1, x2) of the auxiliary sheet (103) based on any one or more of: number of main sheets (100) in the book, and thickness of each of the main sheets (101) in the book. In a second embodiment, the adjuster adjusts the width (x1, x2) of the auxiliary sheet (103) by cutting the auxiliary sheet (103) along the first edge, wherein the width (x1, x2) of the auxiliary sheet (103) is adjusted based on the position of the main sheet (101) in the book on which the auxiliary sheet (103) is coupled by the adhesive strip (105). In a third embodiment, the adjuster adjusts the gutter-size (g1,g2) by adjusting relatively position of the first receiver and the second receiver and the gutter-size (g1,g2) is adjusted based on the position of the main sheet (101) in the book on which the auxiliary sheet (103) is coupled by the adhesive strip (105). In a fourth embodiment, the adjuster includes one or more motors for enabling adjustment of the width (x1,x2) of the auxiliary sheet 103 and the gutter-size (g1,g2). In a fifth embodiment, the disposer provides a continuous supply of the adhesive strip (105) and the machine is provided with cutters (121), to cut the adhesive strip (105). In a sixth embodiment, the second receiver receives a continuous supply of the auxiliary sheet (103) and the machine is provided with cutters (121), to cut the auxiliary sheet (103). In a seventh embodiment, the machine comprises a processor to control the adjuster, the first receiver the second receiver and the disposer. In a eighth embodiment, the disposer disposes a peel-off type of adhesive strip (105) and include a release collector (119) that collects peeled-release (115) that is peeled-off from the adhesive strip (105) to expose adhesive side of the adhesive strip (105).

According to another aspect, the subject matter provides a method for manufacturing a machine for processing sheets to prepare them for binding to form a book comprising: providing a first receiver to receive a main sheet (101); characterized in that providing a second receiver to receive an auxiliary sheet (103); providing a disposer to dispose an adhesive strip (105) to couple the main sheet (101) and the auxiliary sheet (103) and to form a gutter (107) between the main sheet (101) and the auxiliary sheet (103), wherein the distance (g1, g2) between the main sheet 101 and the auxiliary sheet (103) is a gutter-size (g1,g2); and an adjuster to adjust relative position of the main sheet (101) and the auxiliary sheet (103) and any one or both of the gutter-size (g1,g2) and width (x1, x2) of the auxiliary sheet (103) based on the position of the main sheet (100) in the book, and wherein the first receiver and the second receiver positions the auxiliary sheet (103) adjacent to a first edge of the main sheet (101); wherein the first edge is proximal to a biding edge of the book. According a ninth embodiment, providing the adjuster includes configuring the adjuster to adjust any one or both of the gutter-size (g1,g2) and width (x1, x2) of the auxiliary sheet (103) based on any one or more of: number of main sheets (100) in the book, and thickness of each of the main sheets (101) in the book. According a tenth embodiment, providing the adjuster includes configuring the adjuster to adjusts the width (x1, x2) of the auxiliary sheet (103) by cutting the auxiliary sheet (103) along the first edge, wherein the width (x1, x2) of the auxiliary sheet (103) is adjusted based on the position of the main sheet (101) in the book on which the auxiliary sheet (103) is coupled by the adhesive strip (105). According to an eleventh embodiment, providing the adjuster includes configuring the adjuster to adjusts the gutter-size (g1,g2) by adjusting relatively position of the first receiver and the second receiver and the gutter-size (g1,g2) is adjusted based on the position of the main sheet (101) in the book on which the auxiliary sheet (103) is coupled by the adhesive strip (105). According to a twelfth embodiment, providing the adjuster includes providing one or more motors for enabling adjustment of the width (x1,x2) of the auxiliary sheet 103 and the gutter-size (g1,g2). According to thirteenth embodiment, providing the disposer includes configuring the disposer to provide a continuous supply of the adhesive strip (105) and providing cutters (121), to cut the adhesive strip (105). According to a fourteenth embodiment, providing the second receiver includes configuring the second receiver to receive a continuous supply of the auxiliary sheet (103) and providing a cutters (121) to cut the auxiliary sheet (103). According to a fifteenth embodiment, the method includes providing a processor to control the adjuster, the first receiver the second receiver and the disposer.

### BRIEF DESCRIPTION OF THE DRAWINGS

The matter is discussed with reference to the following figures, in that:

FIG. 1a through FIG. 1c are illustrations according to the Japanese patent document JP H09123636;

FIG. 2a through FIG. 2d are illustrations according to the US Patent document U.S. Pat. No. 9,440,479B2;

FIG. 3a through FIG. 3c show limitations associated with the Japanese Patent document JP H09123636 as discussed in the US Patent document U.S. Pat. No. 9,440,479B2;

FIG. 4a through FIG. 4c show illustrations of output and its limitations of the US Patent document U.S. Pat. No. 9,440,479B2;

FIG. 5a through FIG. 5c show illustration of edge to edge printing and output of the sheet processing according to the US Patent document;

FIG. 6a through FIG. 6c show a method of processing sheet according to an embodiment of the present subject matter;

FIG. 7a through FIG. 7f show examples of possible book binding configuration that may be obtained according to the present subject matter;

FIG. 8a through FIG. 8e shows a layout of a concept diagram of the machine according to one embodiment of the present subject matter; and

FIG. 9a and FIG. 9b show examples of output sheets according to the present subject matter.

### DESCRIPTION OF THE EMBODIMENTS

The present subject matter provides a sheet processing method and machine thereof. The subject matter also provides a method of manufacturing the machine. It must be noted that the following discussion and terminologies are intended only for illustration and the singular forms “a”, “an”, and “the” include plural references unless the context clearly expressly dictates otherwise.

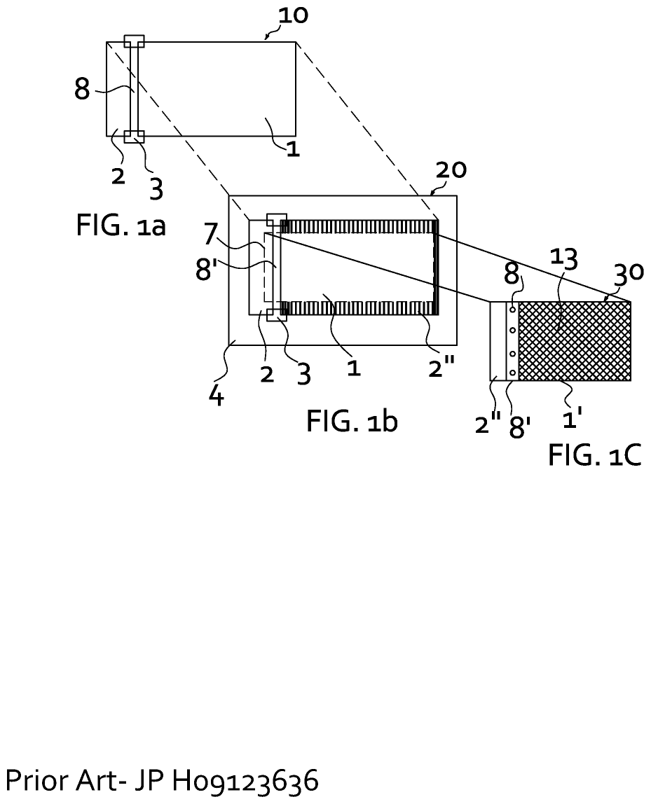

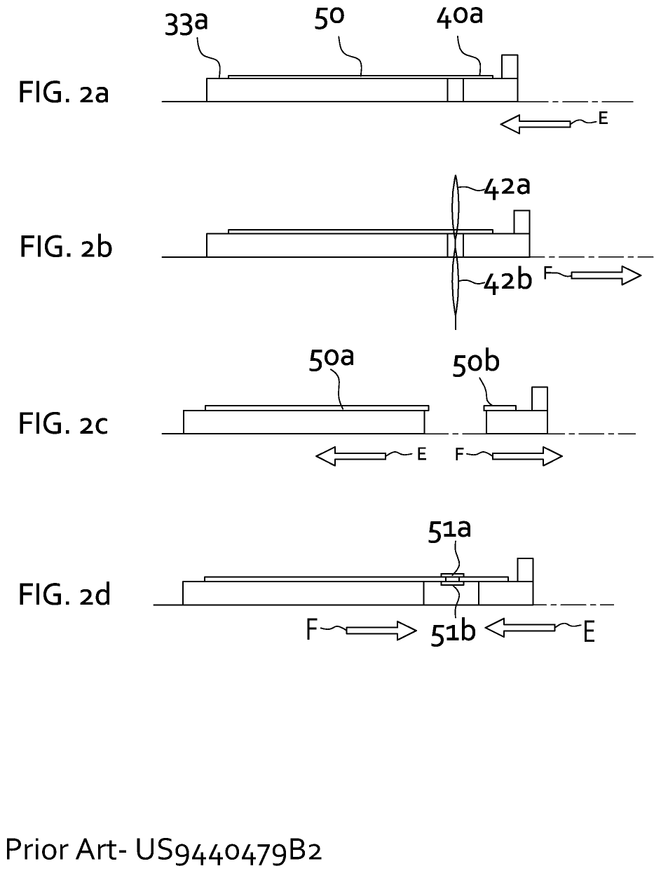

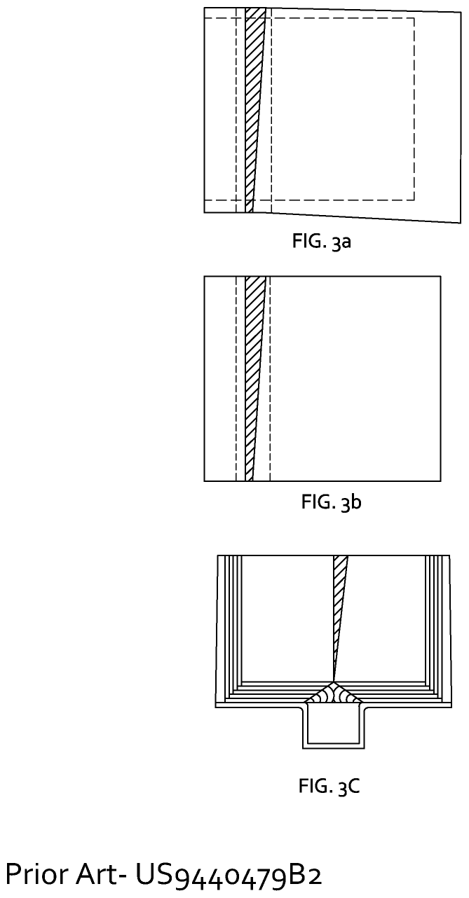

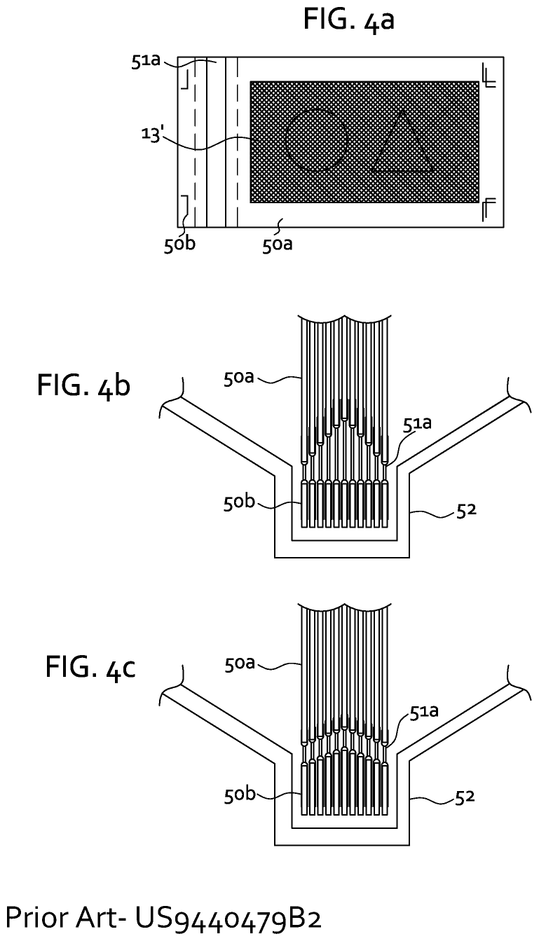

FIG. 4a through FIG. 4b show output of the referred US Patent document. From FIG. 4a through FIG. 4b and corresponding discussion in the US Patent document, it is clear that the document assumes that printed sheet has a binding margin portion 50b and a image portion 50a and that cutting part of the binding margin portion 50b would not result in any loss of printed material, leaving the image portion 50a area shown by hashed area 13′ unharmed. FIG. 4b shows different combination of gaps that may be left between the image portion 50a and binding margin portion 50b of sheets. FIG. 4c shows that the gap between the image portion 50a and binding portion 50b may be kept constant but the position of cut on the biding portion 50b may be adjusted. Similarly for implementing the solution of the Japanese Patent document it is clear that it also requires leaving margin so that sheet may be cut once lamination is performed. From FIG. 1c of Japanese Patent document and FIG. 4a of US Patent document both require provide for printing on the hashed area 13 and 13′ respectively only. That is the area on a sheet excluding the hashed area 13 and 13′ is wasted. To employ the solutions of the referred prior arts would force either the content on the sheet is scaled down, or a larger sheet size is used so that after cutting the sheet, no loss of the printed material occurs. In all, having margin (see, 50b of FIG. 2a or item 2″ of FIG. 1b) is critically important for obtaining a final product in both the above solutions.

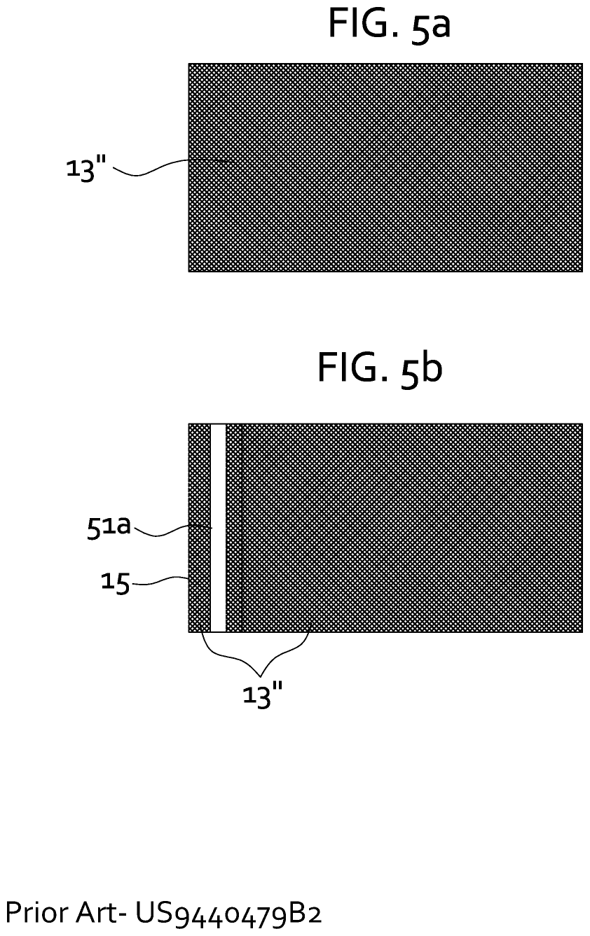

However, with evolution of printing technology it has now become possible to print on the entire sheet without need of leaving any margin. That is, edge to edge printing on sheets is now possible. One such example of sheet is shown in FIG. 5a in which entire hashed area 13″ on the sheet is printed. Also, to waste sheet in margin is also not desirable. Furthermore, in some cases printed sheets are often already laminated or synthetic in nature therefore further laminating sheets may jeopardize the quality of the printing. For such sheet both the solutions of Japanese Patent Document as well as the US Patent document fail, because any cut some portion of the sheet, which results in loss of printed information. One example of lost printed area 15 is shown in FIG. 5b.

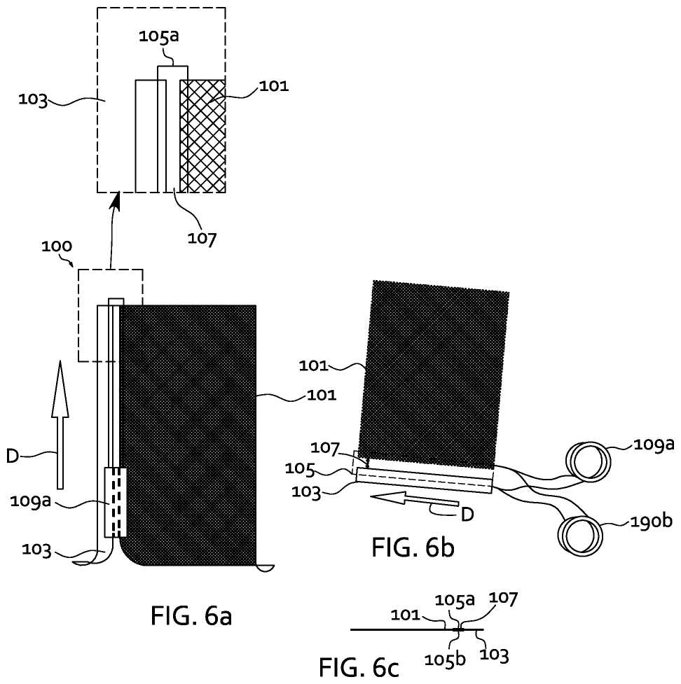

The present subject matter provides a solution that solves the above and other problems associated with the prior art. FIG. 6a through FIG. 9b show various embodiments of the subject matter. Each of the FIG. 6a through FIG. 9b includes reference numerals. It must be noted that the similar feature of FIG. 6a through FIG. 9b are represented by the same reference numerals throughout the drawings and therefore have been narrated only once. The machine, its construction, function and the method of manufacturing are being discussed collectively in the following discussion. The features shows in the FIG. 6a through FIG. 9b are as follows.

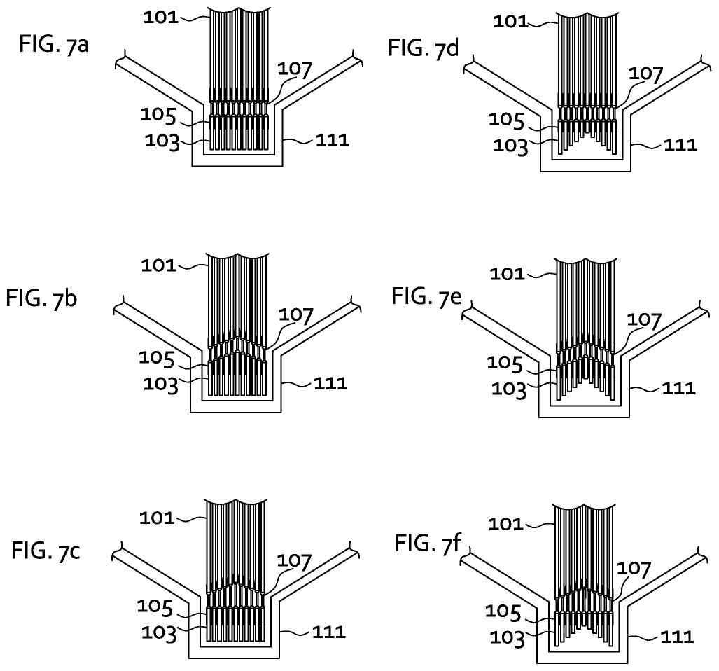

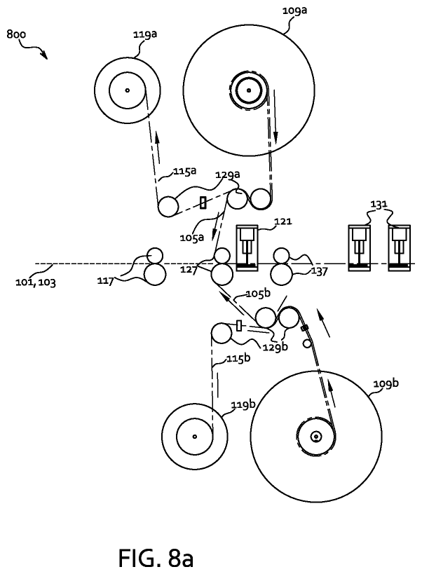

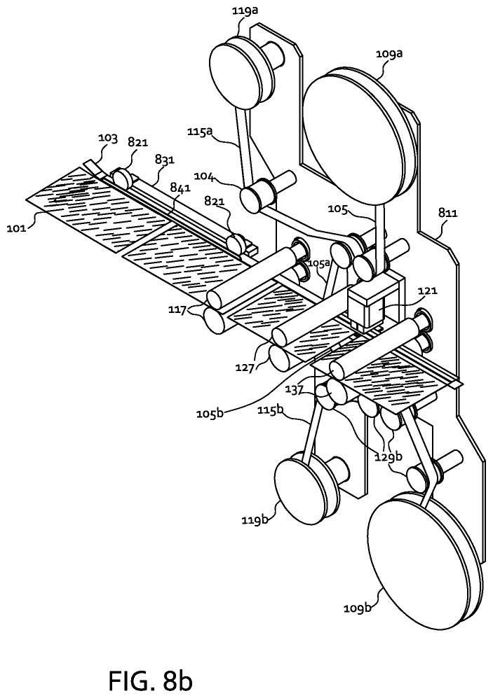

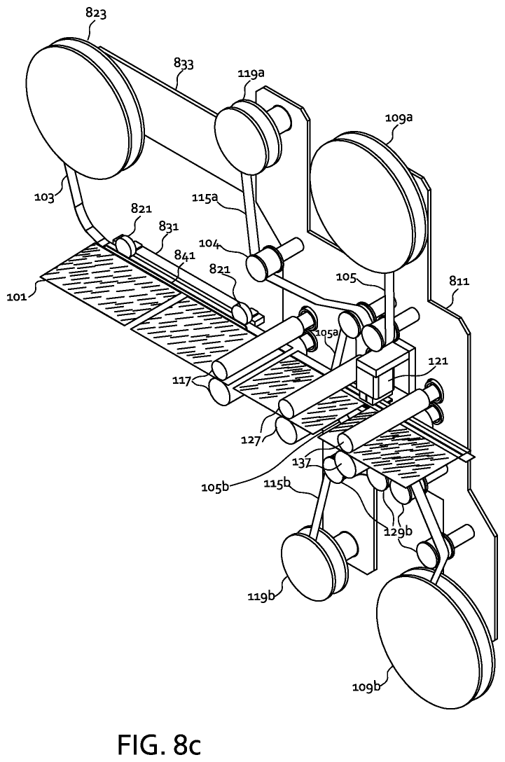

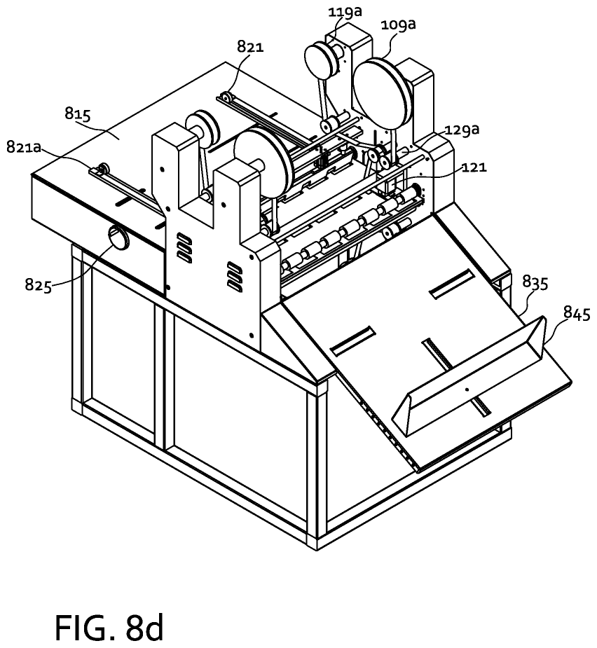

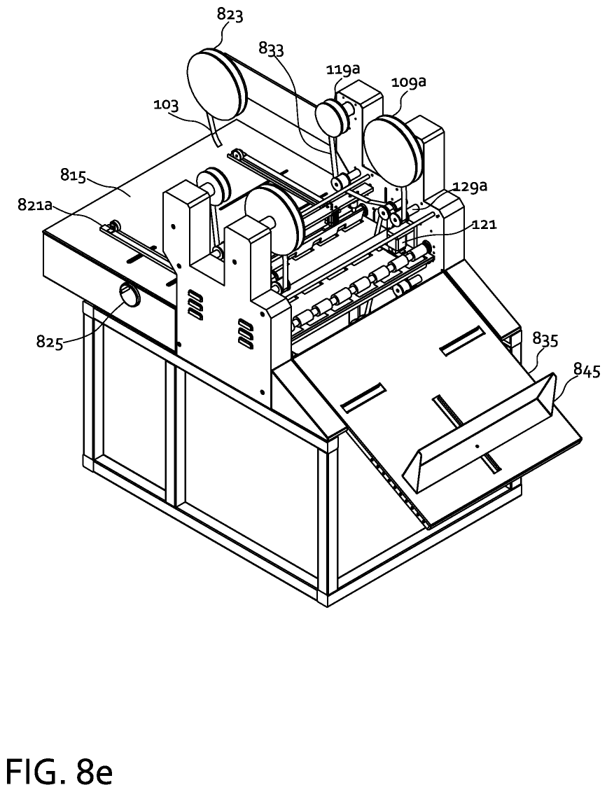

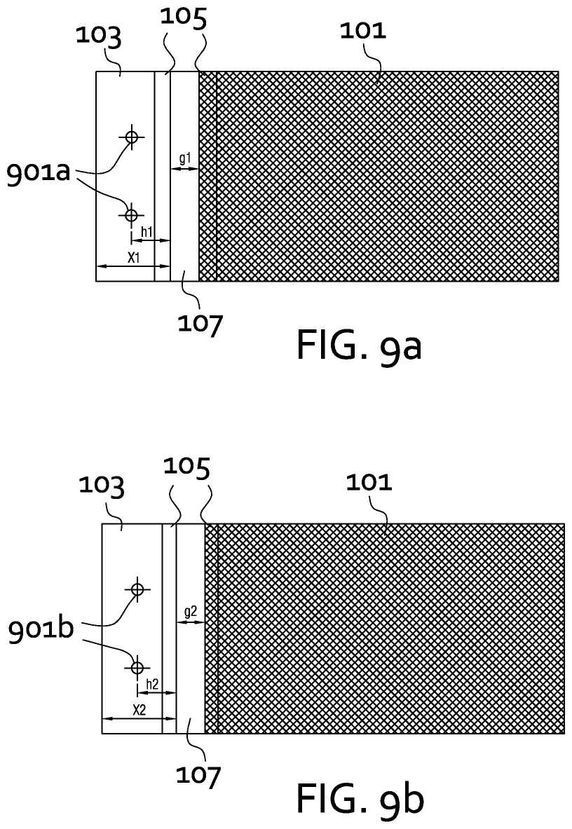

FIG. 6a and FIG. 6b, show a main sheet 101, an auxiliary sheet 103, adhesive strips 105a and 105b (collectively referred to as adhesive strip 105), a gap 107 (referred to as a gutter 107 in subsequent discussion), adhesive roles 109a and 109b (collectively referred to as adhesive role 109), direction D of motion of the main sheet 101, the auxiliary sheet 103 and adhesive strip 105. FIG. 7a-FIG. 7e show different combinations for binding to achieve a book. Each book shown in FIG. 7a-FIG. 7e has output sheets each output sheet having the main sheet 101, auxiliary sheet 103, adhesive strip 105, gutter 107, and a binding edge 111 of the book. FIG. 8a shows a layout of the machine 800. In that, additional features shown are guide-rollers 117, 127 and 137, cutters 121 and 131, release collectors 119a and 119b, adhesive guides 129a and 129b. FIG. 8b shows perspective view of the machine 800 according to an embodiment of the present subject matter. FIG. 8b shows additional feature of a mounting plate 811 and the strip-guide, the strip-guide may comprises stripe-rollers 821, a guide-gutter 841 and a strip support 831. FIG. 8c shows another embodiment of the present subject matter in that includes additional features of a strip-disposer 823 and a mount thereof, namely, strip-disposer mount 833. FIG. 8d and FIG. 8e more detailed examples of embodiments of the present subject matter. Additional features shown in FIG. 8d and FIG. 8e elements are: a platform 815, an additional strip-guide 821a, a handle 825, an output tray 835, and a sheet stopper 845. The FIG. 8e show details of the strip-disposer 823 in addition to what has been discussed with reference to FIG. 8d. FIG. 9a and FIG. 9b show some exaggerated examples of the output sheets of the machine 800. In that gutter-size is shown by g1 and g2 respectively. Width of the auxiliary sheet 103 is shown by x1 and x2 respectively. Location of binding operation is show by cross wire holes 901a and 901b respectively.

It shall be clear to a person after reading this specification, that the machine of the present subject matter may include a first receiver. The first receiver may include the guide-rollers 117 (FIGS. 8a, 8b and 8c), feeder tray (not shown), the platform 815 (FIGS. 8d and 8e).

The machine of the present subject matter may include a second receiver. The second receiver may include: stripe-rollers 821, an additional strip-guide 821a (FIG. 8e), the guide-gutter 841 (FIG. 8b and FIG. 8c), stripe-rollers 821 (FIG. 8b, FIG. 8c and FIG. 8d) etc.

The machine of the present subject matter may include a disposer. The disposer may include: the adhesive role 109,(109a and 109b) (FIG. 8a), the release collectors 119a and 119b (FIG. 8a), the guide-rollers 127 (FIG. 8a), the adhesive guides 129a and 129b (FIG. 8a), the adhesive strips 105a and 105b (FIG. 8a) etc.

The machine of the present subject matter may include an adjuster. The adjuster may include the strip support 831 (FIG. 8b and FIG. 8c) for positioning the auxiliary sheet 103 to adjust the gutter-size (g1, g2) (FIG. 9a and FIG. 9b) 107; cutters 121, 131 (FIG. 8a) etc. to cut the auxiliary sheet to adjust the width (x1, x2); the adjuster may also includes one or more motors (not shown) for enabling adjustment of the width of the auxiliary sheet 103 (x1, x2) and the gutter-size (g1, g2). The adjuster may control position of any one or both of the first receiver and the second receiver using the motors to adjust the gutter-size (g1) and/or to position the cutting tool or the auxiliary sheet 103 adjust the width (x1, x2) of the auxiliary sheet 103.

The machine may be provided with a processor to control the adjuster, the first receiver, the second receiver and the disposer. The processor may be configured to operate the machine from remote location, either on a wireless network or over a wired network or a hybrid wired and wireless network.

The machine its construction and functions are now being described in more details. FIG. 6a and FIG. 6b, illustrate basic concept diagram 100 of the present subject matter, in that FIG. 6b is perspective view of FIG. 6a. Both the FIG. 6a and FIG. 6b. In one aspect, the main sheet 101 has the first edge. The first edge is proximal to the biding edge 111 of the book.

The present subject matter provides the auxiliary sheet 103. The auxiliary sheet 103 is coupled to the main sheet 101 along the first edge using the adhesive strips 105. Providing the auxiliary sheet 103 ensure that addition margin becomes available for binding. The binding operations such as, punching, stapling, cutting or other operations relating to the binding are performed on the auxiliary sheet 103.

Further, providing adhesive strip 105 has a number of advantages. For example, the adhesive strip 105 may be transparent. Having a transparent adhesive strip 105 ensures that when it is pasted on the main sheet 101 it does not compromise the printed area, or does not result in loss of any printed material in binding. That is, the matter printed on the main sheet 101 remains available for a user to view even when the main sheet 101 is bound with other sheets to form a book. Furthermore, the adhesive strip 105 is generally softer and more stronger than the main sheet 101 therefore it acts as hinge and pivots the main sheet 101 around the auxiliary sheet 103 thereby making flipping of the main sheet 101 possible and easier when the main sheet 101 is bound in a book.

The adhesive strip 105 is disposed by the adhesive role 109 on which the adhesive strip 105 may be rolled. The adhesive strip 105 is transparent. According to one aspect the adhesive strip 105 (105a and 105b) is affixed on both sides of both the main sheet 101 and the auxiliary sheet 103. FIG. 6c shows side view of the main sheet 101 after the auxiliary sheet 103 and the adhesive strip 105 (105a and 105b) are affixed on it. According to a further aspect of the present subject matter the adhesive strip 105 is affixed on the main sheet 101 and the auxiliary sheet 103 in such a manner that the gutter 107 is left between the auxiliary sheet 103 and the main sheet 101 is formed. According a further aspect of the subject matter size of the gutter 107 between the auxiliary sheet 103 and the main sheet 101 may be controlled (See FIGS. 6b, 7c, and 7f) and may be adjusted as desired. According to yet a further aspect the width of the auxiliary sheet 103 may be adjusted to a desired size, wherein the width is the distance in the direction perpendicularly away from the first edge. In one embodiment, the width of the auxiliary sheet 103 is adjusted by cutting the auxiliary sheet 103. The main sheet 101 and the auxiliary sheet 103 and the adhesive strip 105 processed as above results in a sheet which is referred to as an output sheet.

For making a book, each sheet of the book may be processed to supply a respective auxiliary sheet 103 and the adhesive strip 105 as explained with respect to the main sheet 101 and to obtain a respective output sheets. Once all sheets are processed and output sheets are obtained, the output sheets may be stacked in order in which they need to be bound. The auxiliary sheets 103 of each output sheet may be then used to bind the book. FIG. 7a-FIG. 7e shows some of the possible mechanism in which the book may be bound. As may be clear to a person, after reading this specification, that the FIG. 7a-FIG. 7e show only few output sheets, however more sheets may be bound to form a book. In FIG. 7a it may be seen that consistent length of the gutter 107 and the auxiliary sheet 103 is maintained across the output sheets. In FIG. 7b it may be seen that consistent length of the gutter 107 maintained however, the auxiliary sheet 103 size varies across the output sheets and the auxiliary sheets 103 are aligned such that the gaps 107 form an inverted V-shape. In FIG. 7c it may be seen that consistent length of the auxiliary sheets 103 is maintained across the output sheets, however the gutter 107 across the output sheets is varied. In this configuration the gaps 107 forms a substantially pentagon shape. In FIG. 7d it may be seen that consistent length of the gutter 107 is maintained across the output sheets, however auxiliary sheet 103 across the output sheets are varied and while the gaps 107 are aligned resulting in a substantially inverted V-shape of the auxiliary sheet 103. In FIG. 7e it may be seen that consistent length of the gutter 107 and auxiliary sheet 103 is maintained across the output sheets, however while binding the output sheets, the sheets are positioned such that both the gaps 107 and the auxiliary sheet 103 form a substantially inverted V-shape. In FIG. 7f it may be seen that length of both the gutter 107 and auxiliary sheet 103 is varied across the output sheets, however while binding the sheets the sheets are positioned such that both the gaps 107 and the auxiliary sheet 103 form a substantially inverted V-shape. The V-shape and varied length of the gutter 107 and/or the auxiliary sheet 103 across the output sheets is of specifically of interest because it provides a substantially flat-lay open book. That is when the book is open a bulge in the middle of the book is substantially reduced or gets eliminated.

FIG. 8a shows a layout of the machine 800 according to an embodiment of the present subject matter. It shall become clear, after reading this specification, that the embodiment of FIG. 8a shows side view therefore the main sheet 101, the auxiliary 103, are over lapping and therefore are shown by the dotted lines.

The main sheet 101 and the auxiliary sheet 103 are fed to the guide roller 117. It shall become clear to a person, after reading this specification that the machine 800 is designed for continuous processing of multiple sheets and therefore a number of sheets may be fed sequentially using a feeder tray or some other mechanism. In one option, roll of sheets or a roll having a continuous sheet may feed the machine 800. The machine 800 is provided with the strip-guide (show in FIG. 8b). The purpose of the strip-guide is to control the gutter-size (see g1, g2 of FIG. 9a and FIG. 9b respectively). A processor may be programmed to control the strip-guide to adjust the gutter 107 for each sheet that is being processed. The strip-guide may be controlled using at tool mounted a screw/lever/pneumatic arm driven by a motor, or a lever or pneumatic mechanism. At guide roller 127 the main sheet 101 and the auxiliary sheet 103 is coupled using the adhesive strips 105a and 105b.

As may be observed from the FIG. 8a that the machine 800 is shown to employ peel-off type of adhesive strip. The adhesive roles 109a and 109b dispose the peel-off type of the adhesive strips 105a and 105b. The adhesive guides 129a and 129b respectively peels and exposes the adhesive side of the adhesive strips 105a and 105b respectively. The adhesive guides 129a and 129b also direct the peeled-release 115a and 115b towards the release collector 119a and 119b respectively.

The coupled sheets are passed through the guide roller 127 to guide roller 137 and are passed under the cutter 121. The cutter 121 is provided with a sensor (not show). When the cutter 121 senses end of the main sheet 101 (or in some embodiments, end of the auxiliary sheet 103) and pneumatic actuator is activated to cut the adhesive strip 105 (and, in some embodiments, the auxiliary sheet 103) thereby separating a sheet from immediately following sheet, which gets joined together because of the auxiliary sheet 103 and/or because of the adhesive strip 105. In some cases, further cutters 131 may be provided. The cutter 131 may be hole punching tools or may be strip cutting tools. In some embodiments, at cutter 131 one or more holes may be punched which may acts as guide for binding the sheets. The holes are punched in the auxiliary sheet 103 so that no printed material present on the main sheet 101 is compromised. While binding the sheets, the auxiliary sheet 103 acts as binding margin. Therefore, all binding operations are performed on the auxiliary sheet 103 leaving the main sheet 101 absolutely unaffected by binding process and leaves entire main sheet 101 accessible to a user of the book.

FIG. 9a and FIG. 9b shows some exaggerated examples of the outputs of the machine 800. In this example, the output sheet of FIG. 9a and the output sheet of FIG. 9b are shown to be exactly the same. That is, distances shown in these figures g1 is equal to g2, x1 is equal to x2, h1 is equal to h2. The examples of FIG. 9a and FIG. 9b also sport holes 901a and 901b respectively. It must be clear from the discussion of FIG. 8 that these holes may be caused by the cutters 131 and may act as guides for binding the output sheets. Further, it shall become clear to a person, after reading this specification that in some examples, the output sheets for a given book may not be exactly the same. That is in some cases, g1 may not be equal to g2, x1 may not be equal to x2, h1 may not be equal to h2. Keeping one or more of parameters g1 and g2, or h1 and h2, or x1 and x2 constant and varying some others on different sheets of a book will provide different binding configurations. Some of the configurations are shown in the FIG. 7a through FIG. 7f In some example, it may be possible that there is no need to cut any holes on the sheets. In that case, one or more of cutter 131 of FIG. 8a may be replaced or removed as may be desired. In one example, the strip-guide (shown in FIG. 8b and FIG. 8c.) which controls the gutter 107 may be mounted on a motor driven screw/lever/pneumatic arm for each main sheet 101 and auxiliary sheet 103 the motor may drive the screw/lever/pneumatic arm and adjust the gutter 107. Thereby, for a given book, the gutter 107 (g1, g2 etc.) on each output sheet may be varied to obtained a configuration having a substantially V-shaped profile (example, shown in FIG. 7a through FIG. 7f). Similarly, in another example, the cutter 131 (shown in FIG. 8a) may be mounted on a motor driven screw/lever/pneumatic arm for each main sheet 101 and auxiliary sheet 103 the motor may drive the screw/lever/pneumatic arm and adjust position of the cutter 131 and cut a strip from the auxiliary sheet 103. Thereby, for a given book, the size of auxiliary sheet 103 (x1, x2 etc.) for each output sheet may be varied to obtained a configuration having a substantially V-shaped profile (example, shown in FIG. 7a through FIG. 7f). Similarly, the location of the hole punched on each sheet may also be varied to obtain desired results.

As may be understood by a person, after reading this specification that the present subject matter provides a controller to controller the entire sheet processing. The controller may control operations of the rollers and cutters, the controller may also control disposing of the adhesive strip 105. The controller may also control the operation of the cutters and the strip-guide. The controller may also be provided with a display or graphical user interface for inputting details of a project for processing sheets. The project details may include number of sheets that need to process for the book. The thickness of the sheets, the type of binding desirable. The project detail may also include number of copies of the book that need to be processed. The project details may further include the progression details, where the book needs to be found in V-shape binding. The progression details refer to the change the parameters such as g1 and g2, or h1 and h2, or x1 and x2 for successive sheets. The controller may also be programmed adaptively learn conditions for initiating, continuing and stopping sheet processing based on artificial intelligence. The controller may also be programmed to enable a user to manually operate the machine 800 sheet by sheet. The machine 800 may be provided options to by-pass the controller altogether and operate the machine 800 manually. Based on the project details and available tools, the controller may prompt a use to either provide more details, or more tools or initiate processing. The controller may also be programmed to stop sheet processing automatically, if any one of the tools, raw material or sheet is unavailable, or any other condition that requires reconfiguration or assistance of a human brain.

FIG. 8b shows perspective view of the machine 800 according to an embodiment of the present subject matter. Function and construction of all the elements of the FIG. 8b have been discussed with reference to previous figures, except for mounting plate 811 and the strip-guide may comprises stripe-rollers 821, a guide-gutter 841 and a strip support 831. The mounting 811 is used for mounting various rollers and tools and the rollers are coupled to driving motor through the mounting plate 811. The strip-guide is used for controlling the auxiliary sheet 103 and its position relative to the main sheet 101. As discussed earlier, the strip-guide may be mounted on a motor driven screw/lever/pneumatic arm to control the position of the auxiliary sheet 103 relative to the main sheet 101. In some example, one or more parts of the strip-guide are mounted on the motor driven screw/lever/pneumatic arm. The strip-rollers 821 keep the auxiliary sheet 103 in place. The auxiliary sheet 103 moves through the strip-gutter 841 and the strip support is for providing support to the auxiliary sheet 103 and other elements of the stripe-guide.

FIG. 8c shows another embodiment of the present subject matter. The embodiment has all the elements of the machine 800 shown in FIG. 8a and FIG. 8b. The construction and function of the embodiment show in the FIG. 8c is substantially same as discussed with reference to previous figures, except for an additional element strip-disposer 823 and a mount thereof, namely, strip-disposer mount 833. It shall become clear to a person, after reading this specification, that the strip-disposer 823 may be used to feed the auxiliary sheet 103. In some embodiments, once all the sheets 101 of a book are loaded on a feeder tray, the machine 800 may automatically select each of the sheets 101 and process them one by one based on the parameters or details supplied to the controller. The machine may pull the auxiliary sheet 103 from the strip-disposer 823. The strip-disposer mount 833 may be a part of a continuous mounting plate 811 or may be separately mountable along with the mounting place 811 to form part of the machine 800.

FIG. 8d and FIG. 8e more detailed examples of embodiments of the present subject matter. Features provided reference numerals similar to those previously discussed have the same mining, construction and function. Additional elements are: platform 815, additional strip-guide 821a, handle 825, output tray 835, and sheet stopper 845. The output tray 835 may collect the output sheets, and the sheet stopper 845 may stop the output sheet from falling. It must be clear to a person, after reading this specification, that a robotic jogger may be further supplied. The jogger may pick the output sheet and jog the sheets and prepare the sheets for binding. Another robotic action may place the jogged output sheet on a stapling machine where the sheets may be stapled to form a bound sheets or a book. The platform 815 may receive the main sheet 101 and the auxiliary sheet 103. The additional strip-guide 821a may be used on for cutting strip and pasting adhesive dispense by corresponding adhesive dispenser which is complementary to the primary adhesive rolls 109a, 109b. The FIG. 8e provides additional details of strip-disposer 823 in addition to what has been discussed with reference to FIG. 8d.

While the subject matter may be susceptible to various modifications and alternative forms, specific embodiments have been shown by way of example in the drawings and have been described herein. Alternate embodiments or modifications may be practiced without departing from the spirit of the subject matter. The drawings shown are representative only and may omit or over emphasize some features. Further, the methods disclosed herein may be performed in manner and/or order in which the methods are explained. It should be understood that the subject matter is not intended to be limited to the particular forms disclosed. The subject matter is to cover all modifications, equivalents, and alternatives falling within the spirit and scope of the subject matter as described above.

What is claimed is:

1. A machine for processing sheets for binding the sheets to form a book comprising:
a first receiver to receive a main sheet (101); characterized in that
a second receiver to receive an auxiliary sheet (103);
a disposer to dispose an adhesive strip (105) to couple the main sheet (101) and the auxiliary sheet (103) and to form a gutter (107) between the main sheet (101) and the auxiliary sheet (103), wherein the distance (g1, g2) between the main sheet 101 and the auxiliary sheet (103) is a gutter-size (g1,g2); and
an adjuster to adjust relative position of the main sheet (101) and the auxiliary sheet (103), and any one or both of the gutter-size (g1,g2) and width (x1, x2) of the auxiliary sheet (103) based on the position of the main sheet (100) in the book, and wherein the first receiver and the second receiver positions the auxiliary sheet (103) adjacent to a first edge of the main sheet (101) wherein the first edge is proximal to a biding edge of the book.

2. The machine as claimed in claim 1, wherein the adjuster is configured to adjust any one or both of the gutter-size (g1,g2) and width (x1, x2) of the auxiliary sheet (103) based on any one or more of: number of main sheets (100) in the book, and thickness of each of the main sheets (101) in the book.

3. The machine as claimed in claim 1, wherein the adjuster adjusts the width (x1, x2) of the auxiliary sheet (103) by cutting the auxiliary sheet (103) along the first edge, wherein the width (x1, x2) of the auxiliary sheet (103) is adjusted based on the position of the main sheet (101) in the book on which the auxiliary sheet (103) is coupled by the adhesive strip (105).

4. The machine as claimed in claim 1, wherein the adjuster adjusts the gutter-size (g1,g2) by adjusting relatively position of the first receiver and the second receiver and the gutter-size (g1,g2) is adjusted based on the position of the main sheet (101) in the book on which the auxiliary sheet (103) is coupled by the adhesive strip (105).

5. The machines as claimed in claim 1, wherein the adjuster includes one or more motors for enabling adjustment of the width (x1,x2) of the auxiliary sheet 103 and the gutter-size (g1,g2).

6. The machine as claimed in claim 1, wherein the disposer provides a continuous supply of the adhesive strip (105) and the machine is provided with cutters (121), to cut the adhesive strip (105).

7. The machine as claimed in claim 1, wherein the second receiver receives a continuous supply of the auxiliary sheet (103) and the machine is provided with cutters (121), to cut the auxiliary sheet (103).

8. The machine as claimed in claim 1, wherein the machine comprises a processor to control the adjuster, the first receiver the second receiver and the disposer.

9. The machine as claimed in claim 1, wherein the disposer disposes a peel-off type of adhesive strip (105) and include a release collector (119) that collects peeled-release (115) that is peeled-off from the adhesive strip (105) to expose adhesive side of the adhesive strip (105).

10. A method for manufacturing a machine for processing sheets to prepare them for binding to form a book comprising:
providing a first receiver to receive a main sheet (101); characterized in that
providing a second receiver to receive an auxiliary sheet (103);
providing a disposer to dispose an adhesive strip (105) to couple the main sheet (101) and the auxiliary sheet (103) and to form a gutter (107) between the main sheet (101) and the auxiliary sheet (103), wherein the distance (g1, g2) between the main sheet 101 and the auxiliary sheet (103) is a gutter-size (g1,g2); and
an adjuster to adjust relative position of the main sheet (101) and the auxiliary sheet (103) and any one or both of the gutter-size (g1,g2) and width (x1, x2) of the auxiliary sheet (103) based on the position of the main sheet (100) in the book, and wherein the first receiver and the second receiver positions the auxiliary sheet (103) adjacent to a first edge of the main sheet (101), wherein the first edge is proximal to a biding edge of the book.

11. The method as claimed in claim 10, wherein providing the adjuster includes configuring the adjuster to adjust any one or both of the gutter-size (g1,g2) and width (x1, x2) of the auxiliary sheet (103) based on any one or more of: number of main sheets (100) in the book, and thickness of each of the main sheets (101) in the book.

12. The method as claimed in claim 10, wherein providing the adjuster includes configuring the adjuster to adjusts the width (x1, x2) of the auxiliary sheet (103) by cutting the auxiliary sheet (103) along the first edge, wherein the width (x1, x2) of the auxiliary sheet (103) is adjusted based on the position of the main sheet (101) in the book on which the auxiliary sheet (103) is coupled by the adhesive strip (105).

13. The method as claimed in claim 10, wherein providing the adjuster includes configuring the adjuster to adjusts the gutter-size (g1,g2) by adjusting relatively position of the first receiver and the second receiver and the gutter-size (g1,g2) is adjusted based on the position of the main sheet (101) in the book on which the auxiliary sheet (103) is coupled by the adhesive strip (105).

14. The method as claimed in claim 10, wherein providing the adjuster includes providing one or more motors for enabling adjustment of the width (x1,x2) of the auxiliary sheet 103 and the gutter-size (g1,g2).

15. The method as claimed in claim 10, wherein providing the disposer includes configuring the disposer to provide a continuous supply of the adhesive strip (105) and providing cutters (121), to cut the adhesive strip (105).

16. The method as claimed in claim 10, wherein providing the second receiver includes configuring the second receiver to receive a continuous supply of the auxiliary sheet (103) and providing a cutters (121) to cut the auxiliary sheet (103).

17. The method as claimed in claim 10, wherein the method includes providing a processor to control the adjuster, the first receiver the second receiver and the disposer.
